(19) United States
(12) Patent Application Publication
(10) Pub. No.: US 2009/0131121 A1
(43) Pub. Date: May 21, 2009

(54) BATTERY UTILIZING SYSTEM

(75) Inventors: Yoshihiro IDA, Saitama (JP); Shigeki ITO, Kanagawa (JP); Hiroki SUZUKI, Kanagawa (JP); Hitoaki AKAHORI, Tokyo (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/263,643

(22) Filed: Nov. 3, 2008

(30) Foreign Application Priority Data
Nov. 5, 2007 (JP) 2007-286989

(51) Int. Cl. H04M 1/00

(52) U.S. Cl. 455/572

(57) ABSTRACT

In the battery utilizing system of the present invention, a battery supplying power to a portable terminal includes a memory which stores at least one content and an output permission condition indicating a condition for permitting output of the content, and the portable terminal includes a determining section which determines, on the basis of the output permission condition of the content stored in the memory, whether or not to permit to output the content; and an outputting section which outputs the content which is determined the determining section as a permission of outputting. Therefore, in outputting a content stored in the battery, out of all contents stored in the battery, only a content whose output is permitted is reproduced in the portable terminal, and hence, a necessary content only is reproduced in this battery utilizing system.

### BACKGROUND

The present invention relates to a battery utilizing system;

Prior art relating to battery utilization is described in Patent Document 1 and Patent Document 2. Patent Document 1 discloses a technique relating to a battery providing system and a battery providing method. Patent Document 2 discloses a technique relating to an accounting method and an accounting system used for charging a battery of a cellular phone.

In particular, Patent Document 1 describes that when a battery storing user information has run out and a user brings it to a store, the store receives the used-up battery and attaches it to a battery charger, and the following process is performed.

First, the user information stored in the battery is read by the battery charger and transmitted via a personal computer disposed on the side of the store and a network to a management server disposed on the side of a maker. The management server analyzes the tendency of the user on the basis of the user information transmitted from the store side, so as to return advertisement information, coupon information and the like selected corresponding to the tendency of the user on the basis of the analysis result to the store side. Then, the store writes the advertisement information and the like sent from the management server corresponding to the tendency of the user in the battery having been charged, and the resultant battery is handed to the user.

Through this process, the user can see advertisements corresponding to his/her tendency by reproducing, by using a personal computer or the like, the advertisement information stored in the charged battery handed from the store.

Patent Document 1: JP-A-2003-7348

Patent Document 2: JP-A-2003-18255

In the aforementioned conventional technique, however, the advertisement information and the like transmitted from the management server is stored in the battery, and hence, the whole stored advertisement information and the like is reproduced in reproducing the advertisement information and the like by using a personal computer or the like, and thus, advertisement information or the like to be reproduced cannot be changed depending upon a reproducing state but unnecessary information is disadvantageously reproduced.

### SUMMARY

As a consequence, the present invention is made to solve the above-described problems, and therefore, has an object to provide a battery utilizing system in which a necessary content only can be output in outputting contents stored in a battery through a portable terminal.

In order to overcome the above-described disadvantage and achieve the object, the battery utilizing system of the present invention, comprising:

a portable terminal; and

a battery that supplies power to the portable terminal,

wherein the battery includes a memory which stores at least one content and an output permission condition which indicates a condition for permitting output of the content; and

wherein the portable terminal includes:
a determining section which determines, on the basis of the output permission condition stored in the memory, whether or not to permit to output the content; and
an outputting section which outputs the content determined by the determining, section as a permission of outputting.

According to the present invention, in outputting the content stored in the battery, out of all contents stored in the battery, only the content whose output is permitted is reproduced in the portable terminal, and therefore, a battery utilizing system in which a necessary content only is reproduced is provided.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a diagram schematically showing the outline of a battery utilizing system of the invention;

FIG. 2 is a diagram showing an example of the whole architecture of the battery utilizing system;

FIG. 3 is a block diagram showing an exemplified structure of a battery included in the battery utilizing system;

FIG. 4 is a diagram showing an exemplified data structure of a content stored in a memory section;

FIG. 5 is a diagram showing an exemplified data structure of a header of a content used when the content is a coupon or an advertisement;

FIG. 6 is a diagram showing an exemplified data structure of a header of a content used when the content is a musical piece;

FIG. 7 is a block diagram showing another exemplified structure of the battery included in the battery utilizing system;

FIG. 8 is a block diagram showing an exemplified structure of a content management server and a POS terminal included in the battery utilizing system;

FIG. 9 is a block diagram showing an exemplified structure of a charging station included in the battery utilizing system;

FIG. 10 is a block diagram showing an exemplified structure of a cellular phone and another exemplified structure of the battery included in the battery utilizing system;

FIG. 11 is a flowchart showing exemplified procedures in a process for delivery of a coupon/advertisement file performed in the battery utilizing system;

FIG. 12 is a flowchart showing exemplified procedures in a process for user information registration and installation of a coupon/advertisement browser application performed in the battery utilizing system;

FIG. 13 is a flowchart showing exemplified procedures in a process for browsing of a coupon/advertisement file and registration of a favorite performed in the battery utilizing system;

FIG. 14 is a flowchart showing exemplified procedures in a process for installation of a coupon/advertisement browser application and browsing of a coupon/advertisement file performed on initial connection of a battery to a cellular phone in the battery utilizing system;

FIG. 15 is a flowchart showing exemplified procedures in a process for use of a coupon/advertisement file and settlement (No. 1) through cooperation with POS performed in the battery utilizing system;

FIG. 16 is a flowchart showing exemplified procedures in a process for use of a coupon/advertisement file and settlement (No. 2) through cooperation with POS performed in the battery utilizing system;

FIG. 17 is a flowchart showing exemplified procedures in a process for browsing of a fortune-telling content performed in the battery utilizing system;

FIG. 18 is a flowchart showing exemplified procedures in a process for trial listening and purchase of a music content performed in the battery utilizing system; and

FIG. 19 is a flowchart showing exemplified procedures in a process for partial browsing and purchase of a book content performed in the battery utilizing system.

### DETAILED DESCRIPTION OF EXEMPLARY EMBODIMENTS

Exemplary embodiments of a battery utilizing system, according to the present invention will now be described in detail with reference to the accompanying drawings. It is noted that the invention is not limited to the embodiments.

### 1. Outline of Embodiments

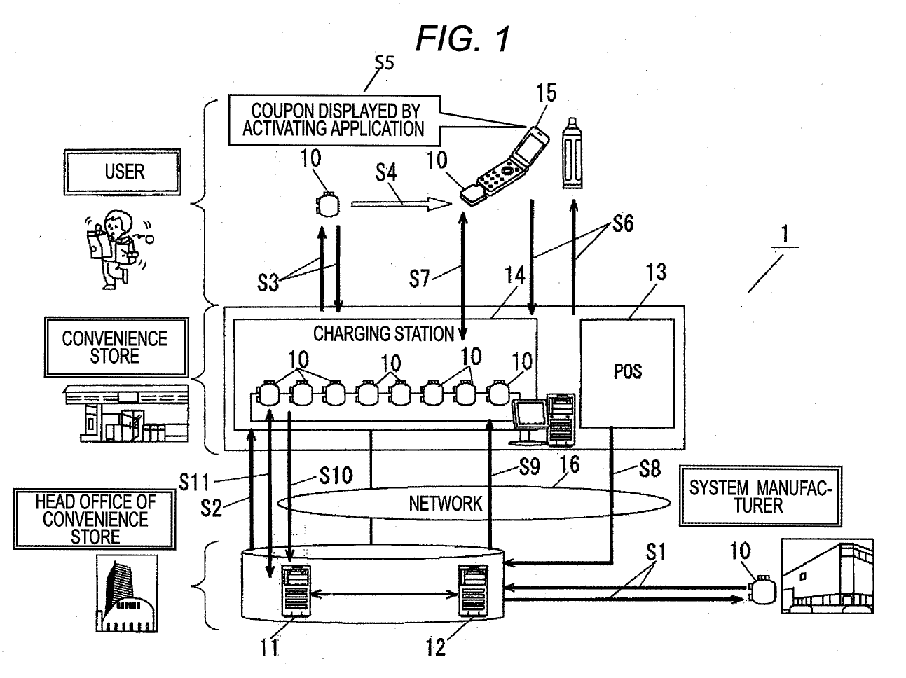

The outline of a battery utilizing system according to an embodiment will now be described with reference to FIG. 1.

FIG. 1 is a diagram schematically showing the outline of the battery utilizing system 1. In FIG. 1, the reference numeral 1 denotes the battery utilizing system, a reference numeral 10 denotes a battery, a reference numeral 11 denotes a content management server, a reference numeral 12 denotes a POS management server, a reference numeral 13 denotes a POS (Point Of Sales) terminal, a reference numeral 14 denotes a charging station, a reference numeral 15 denotes a cellular phone, and a reference numeral 16 denotes a network.

The battery utilizing system 1 includes the battery 10, the content management server 11, the POS management server 12, the POS terminal 13, the charging station 14 (a battery charger), the cellular phone 15 (a portable terminal), possessed by a user, and the network 16. The content management server 11 and the POS management server 12 are set in a head office (hereinafter sometimes referred to as the office) of a convenience store (hereinafter sometimes referred to as the store). The POS terminal 13 and the charging station 14 are set in the store. It is noted that the POS management server 12 and the POS terminal 13 may be a server and a terminal already existing respectively in the office and the store.

Next, at business model utilizing the battery utilizing system 1 (from the introduction to the utilization of the battery utilizing system 1) will be described with reference to FIG. 1.

First, the office purchases the battery 10, the content management server 11 and the charging station 14 included in the battery utilizing system 1 at a system manufacturer for a given price (S1). Next, the office rents the battery 10 and the charging station 14 purchased in S1 to the store (S2).

When a user possessing the cellular phone 15 goes to the store, the user buys the battery 10, which has been charged and stores a given coupon or a given application program previously transmitted from the content management server 11 set in the office, for a given price at the store (S3). Then, the user inserts the battery 10 bought in S3 into the cellular phone 15 possessed by the user as shown in FIG. 1 (S4). Thus, the application program stored in the battery 10 is automatically activated, so as to display the coupon stored in the battery 10 on a screen of the cellular phone 15 (S5).

When the user buys merchandise by using the coupon at the store, the user holds the screen of the cellular phone 15 displaying the coupon over a reader connected to the POS terminal 13, so as to pay a price calculated by discounting a reduced price shown in the coupon from the proper price of the merchandise in cash or electronic money (S6).

When the battery 10 bought in S3 has been run out and cannot be used for the cellular phone 15, the user goes to the store and exchanges the battery 10 with another charged battery 10 placed in the charging station 14 free of charge (S7). In exchanging the battery 10, the charging station 14 may transfer a coupon stored in the battery 10 brought by the user to the charged battery 10 to be given to the user so as to take over the coupon.

The POS terminal 13 transmits, at a given timing, POS information on actual results of sales, marketing and the like of merchandise as well as coupon use history information on coupon use history (coupon use results) to the POS management server 12 via the network 16 (S8). Next, the POS management server 12 receives the POS information and the coupon use history information transmitted in S8 and determines a coupon to be newly stored in the battery 10 by analyzing these pieces of information in cooperation with the content management server 11, and the determined coupon is transmitted to the charging station 14 via the network 16 (S9).

When the charging station 14 determines that the life of a battery 10 placed therein has expired, it transmits a battery life alert for informing the expiration to the content management server 11 via the network 16 (S10). Next, a person on duty of the office confirms the battery life alert transmitted in S10 through the content management server 11 and exchanges the battery 10 specified by the battery life alert with a fresh battery 10 (S11).

In this manner, corresponding to the business model using the battery utilizing system 11 the exchange cost for the battery 10 (corresponding to a cost necessary for exchanging a purchased battery 10 with another battery and excluding a cost of the first purchase) can be made free by utilizing the sales increased by advertisements of the store where the charging station 14 is set.

Furthermore, an effect to attract customers to the store can be expected due to an added value not limited to the charge of the battery 10 (specifically, an added value of providing coupons). For example, when a supermarket or a department store utilizes the battery 10 as a coupon, the attraction of the supermarket or the department store for drawing customers can be increased. Also, since an electronic coupon is used, the coupon can be distributed simply and efficiently to the same extent as the electronic money without increasing the cost as compared with use of a paper coupon.

Moreover, since the battery is manually exchanged and no IT knowledge is necessary for the exchange, the battery utilizing system 1 can be easily utilized particularly by the elderly who are not comfortable with handling gadgets. Furthermore, when the battery 10 stores a questionnaire content, the results of questionnaires can be collected from batteries 10 in exchanging the batteries 10, and therefore, not only can the results of the questionnaires be grasped but also an appropriate coupon can be stored in the battery 10 on the basis of the analysis of the questionnaire results. In addition, the battery 10 may be, for example, a compact fuel cell.

### 2. System Architecture

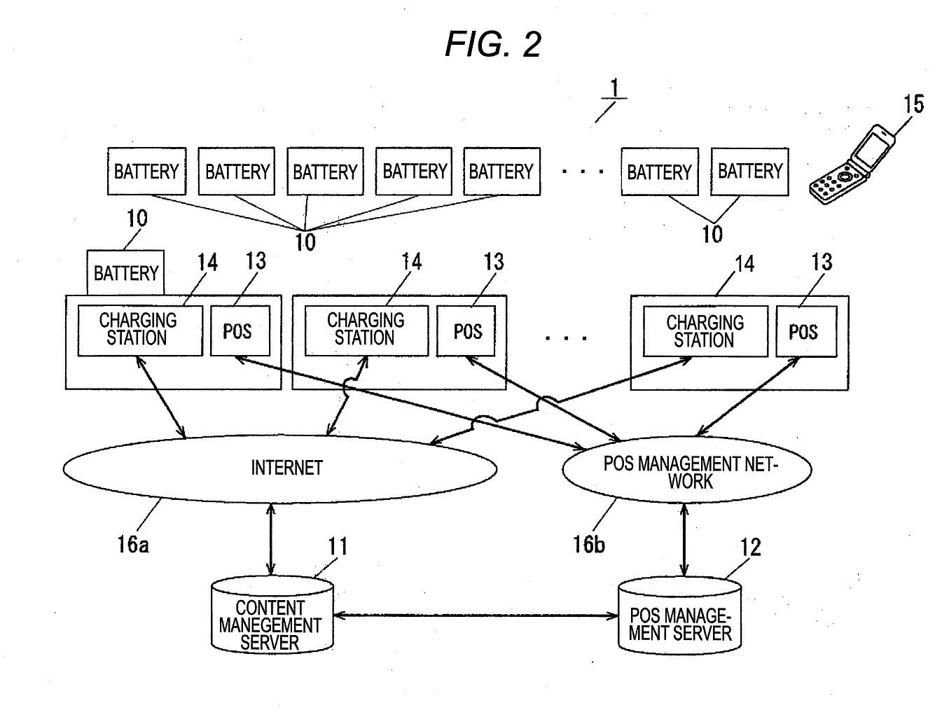

The architecture of the battery utilizing system 1 will now be described with reference to FIGS. 2 through 10.

FIG. 2 is a diagram showing an example of the whole architecture of the battery-utilizing system 1. In FIG. 2, the reference numeral 1 denotes the battery utilizing system, a reference numeral 10 denotes a battery, a reference numeral 11 denotes a content management server, a reference numeral 12 denotes a POS management server, a reference numeral 13 denotes a POS terminal, a reference numeral 14 denotes a charging station, a reference numeral 15 denotes a cellular phone, a reference numeral 16a denotes the Internet, and a reference numeral 16b denotes a POS management network.

The battery utilizing system 1 includes the battery 10, the content management server 11, the POS management server 12 that manages POS information, etc., on actual results of sales, marketing and the like of merchandise, the POS terminal 13, the charging station 14, the cellular phone 15, the Internet 16a and the POS management network 16b.

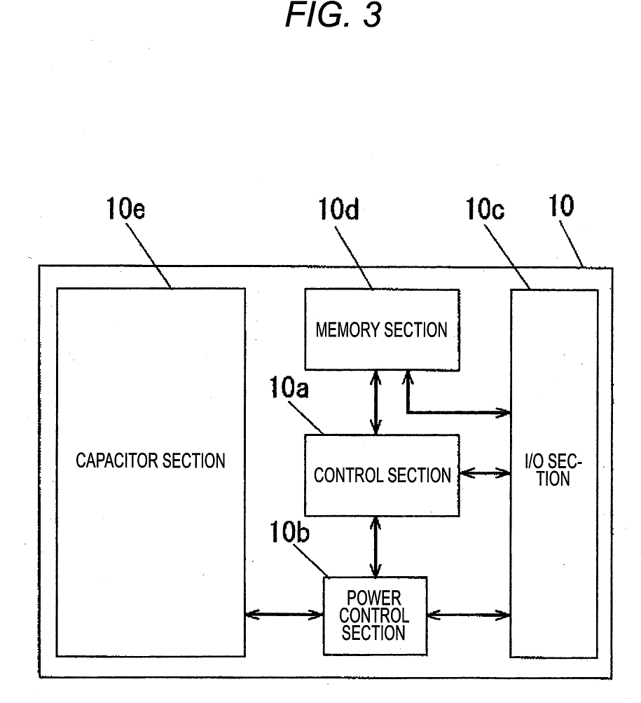

FIG. 3 is a block diagram showing an exemplified structure of the battery 10 included in the battery utilizing system 1. In FIG. 3, the reference numeral 10 denotes the battery, a reference numeral 10a denotes a control section, a reference numeral 10b denotes a power control section, a reference numeral 10c denotes an I (input)/O (output) section, a reference numeral 10d denotes a memory section and a reference numeral 10e denotes a capacitor section.

The battery 10 includes the control section 10a, the power control section 10b, the I/O section 10c, the memory section 10d and the capacitor section 10e, and these sections are connected to one another to be able to communicate with one another via arbitrary communication paths. The battery 10 may include an operation key to be used for displaying a content.

The control section 10a is a CPU or the like for generally controlling the battery 10. The power control section 10b controls electricity flow between the capacitor section 10e and the I/O section 10c. Specifically, the power control section 10b allows electricity stored in the capacitor section 10e to flow to the I/O section 10c so as to supply electricity to the cellular phone 15 connected to the I/O section 10c or allows electricity to flow from the I/O section 10c to the capacitor section 10e so as to receive electricity supply from the charging station 14 connected to the I/O section 10c. The I/O section 10c is an interface (connection I/F) connectable to the cellular phone 15 and the charging station 14, and acts as an intermediary in input/output of electricity and information between the battery 10 and the cellular phone 15 or the charging station 14.

The memory section 10d (a battery side memory section) stores a content, a content browser application (such as a coupon/advertisement browser application), that is, an application program concerned with a process for browsing the content and a content viewing application, that is, an application program concerned with a process for viewing the content. At this point, the content may include at least one of, for example, an electronic coupon, an electronic advertisement, a guidance of facilities (such as a theme park, a museum or an aquarium), explanation of an event held by facilities, explanation of an exhibit put on display in facilities, an electronic musical piece, an electronic book and fortune-telling information. Furthermore, a plurality of flagged contents may be downloaded to the memory section 10d. Such a flag may be controlled, for example, corresponding to time measured by the cellular phone 15. Furthermore, the memory section 10d may store a content concerned with a guidance of facilities (such as a theme park, a museum or an aquarium), explanation of an event held by facilities or explanation of an exhibit put on display in facilities together with output permission range information on a range of permitting the output of the content. The capacitor section 10e stores electricity.

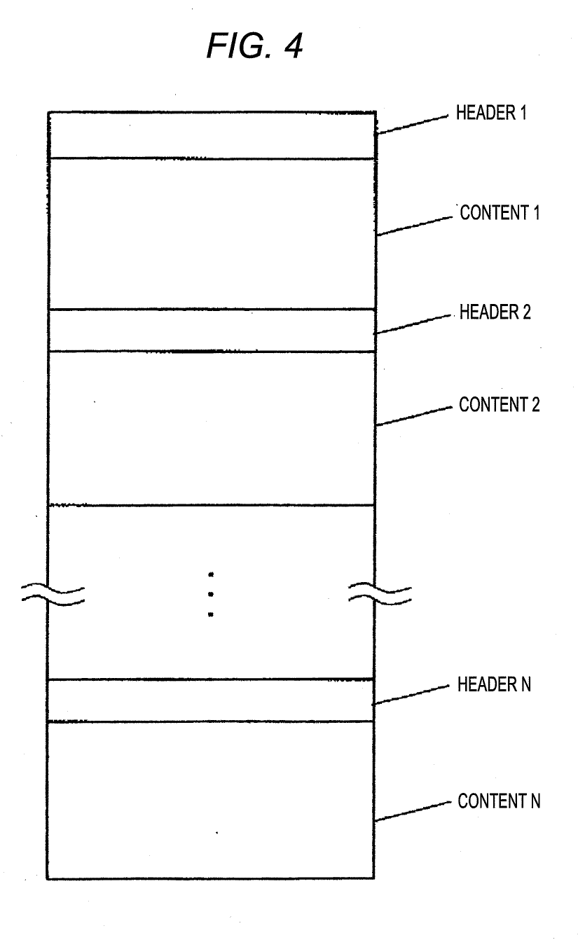

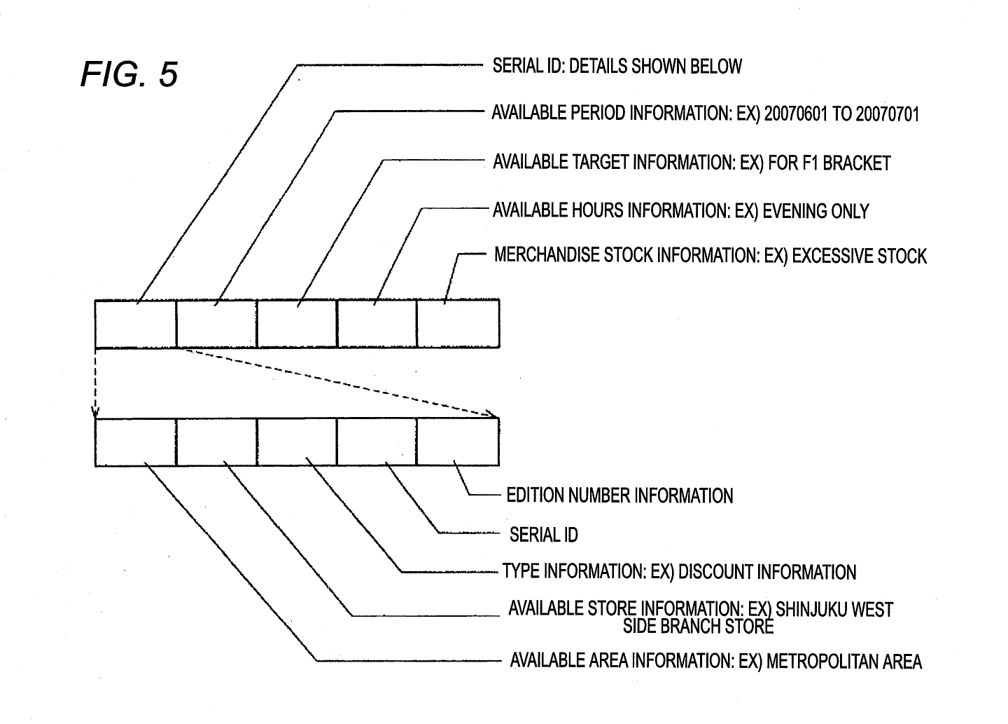

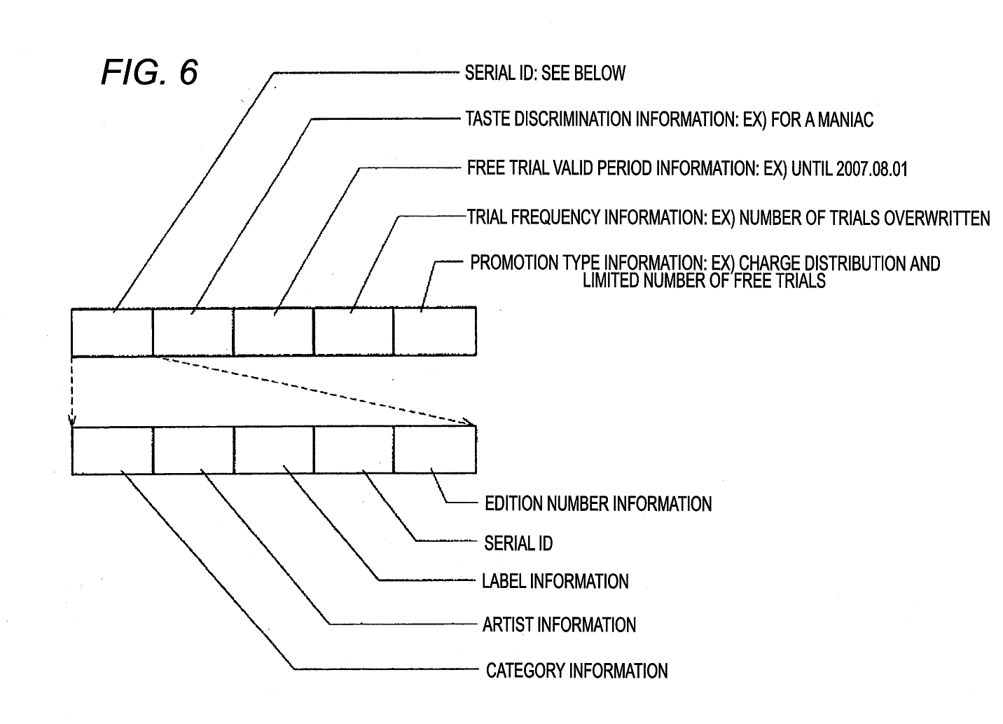

FIG. 4 is a diagram showing an exemplified data structure of a content stored in the memory section 10d. As shown in FIG. 4, the content is stored in the memory section 10d in combination with a header shown in FIG. 5 or 6.

FIG. 5 is a diagram showing an exemplified data structure of the header used when the content is a coupon or an advertisement. As shown in FIG. 5, the header includes a serial ID, available period information, available target information, available hours information and merchandise stock information.

The serial ID includes available area information, available store information, type information, a serial number and edition number information. The available area information is information on an area where the coupon/advertisement is provided and, is described as, for example, “Metropolitan area.” The available store information is information on stores where the coupon/advertisement is usable, and is described as, for example, “Shinjuku west side branch store.” The type information is information on the type of merchandise dealt with in the coupon/advertisement, and is described, for example, as “discount information.”

Furthermore, the available period information is information on a period when the coupon/advertisement is provided, and is described, for example, as “2007.06.01-2007.07.01.” Also, the available target information corresponds to output permission target information of the present invention, is information on a feature of a target to which the coupon/advertisement is provided, and is described, for example, as “for an F-1 bracket.” In addition, the available hours information is information on hours when the coupon/advertisement is provided, and is described, for example, as “only evening.” Furthermore, the merchandise stock information is information on a stock of merchandise dealt with in the coupon/advertisement, and is described, for example, as “excessive stock.”

FIG. 6 is a diagram showing an exemplified data structure of the header used when the content is music. As shown in FIG. 6, the header includes a serial ID, taste discrimination information, free trial valid period information, trial frequency information and promotion type information.

The serial ID includes category information, artist information, label information, a serial number and edition number information. The category information is information on the category of the music. The artist information is information on a composer, a songwriter and a performer of the music. The label information is information on the label of the music.

Furthermore, the taste discrimination information is information used for discriminating the taste of a listener of the music, and is described, for example, as “for a maniac.” Also, the free trial valid period information is information on a period when the music can be listened to for free, and is described, for example, as “until 2007.08.01.” Moreover, the trial frequency information is rewritable information on the number of times of listening to the music. In addition, the promotion type information is information on the type of promotion of the music, and is described, for example, as “charge distribution” or “limited in number of free trials.”

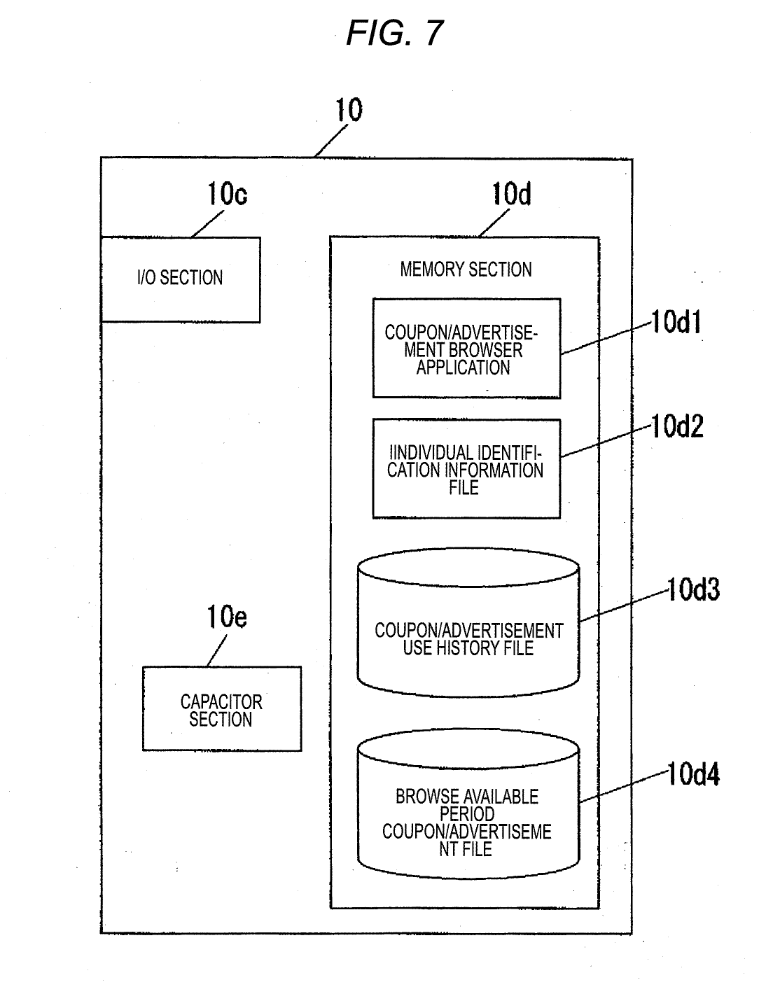

FIG. 7 is a block diagram showing another exemplified structure of the battery 10 included in the battery utilizing system 1. In FIG. 7, the reference numeral 10 denotes the battery, a reference numeral 10c denotes an I/O section, a reference numeral 10d denotes a memory section, a reference numeral 10d1 denotes a coupon/advertisement browser application, a reference numeral 10d2 denotes an individual identification information file, a reference numeral 10d3 denotes a coupon/advertisement use history file, a reference numeral 10d4 denotes a browse available period coupon/advertisement file and a reference numeral 10e denotes a capacitor section.

The memory section 10d stores the coupon/advertisement browser application 10d1, the individual identification information file 10d2, the coupon/advertisement use history file 10d3 and the browse available period coupon/advertisement file 10d4.

The coupon/advertisement browser application 10d1 is an application program concerned with a process for browsing a coupon/advertisement file. The individual identification information file 10d2 stores individual identification information for identifying the battery 10 as an individual. The coupon/advertisement use history file 10d3 stores coupon/advertisement use history information on the use history of coupon/advertisement files. The browse available period coupon/advertisement file 10d4 stores a coupon/advertisement file corresponding to each browse available period (of, for example, a time, a date or a week). The browse available period coupon/advertisement file 10d4 may have a two-level structure of coupon/advertisement files and a file retrieval table for retrieving the coupon/advertisement files.

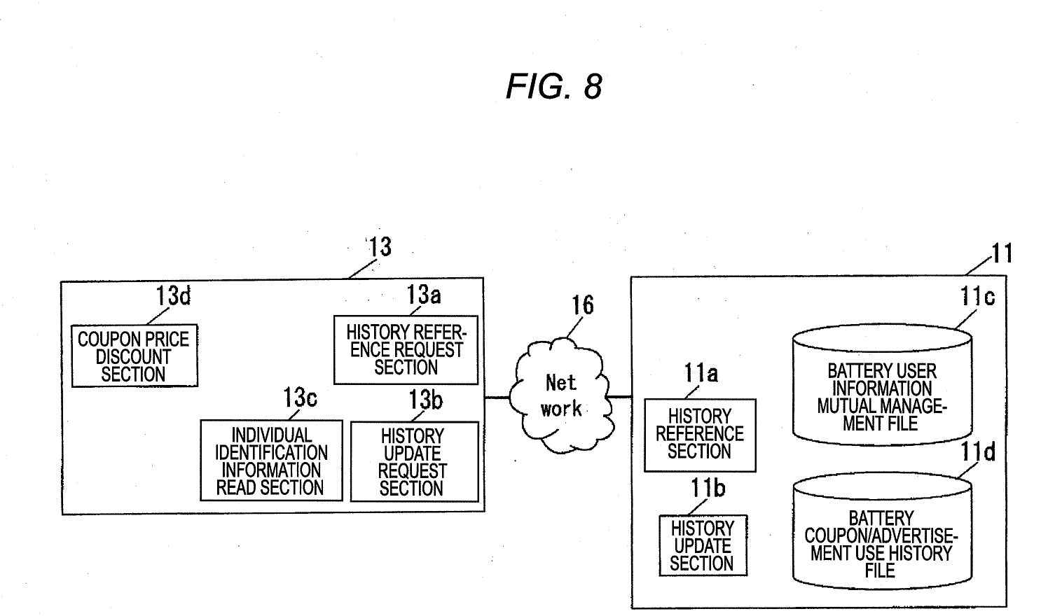

FIG. 8 is a block diagram showing an exemplified structure of the content management server 11 and the POS terminal 13 included in the battery utilizing system 1. In FIG. 8, the reference numeral 11 denotes the content management server, a reference numeral 11a denotes a history reference section, a reference numeral 11b denotes a history update section, a reference numeral 11c denotes a battery user information mutual management file, a reference numeral 11d denotes a battery coupon/advertisement use history file, the reference numeral 13 denotes the POS terminal, a reference numeral 13a denotes a history reference request section, a reference numeral 13b denotes a history update request section, a reference numeral 13c denotes an individual identification information read section, a reference numeral 13d denotes a coupon price discount section, and a reference numeral 16 denotes a network.

The content management server 11 includes the history reference section 11a, the history update section 11b, the battery user information mutual management file 11c and the battery coupon/advertisement use history file 11d.

The history reference section 11a refers to the battery coupon/advertisement use history file 11d for coupon/advertisement use history information specified by a history reference request sent from the history reference request section 13a and transmits the referred information to the POS terminal 13. The history update section 11b updates coupon/advertisement use history information specified by a history update request sent from the history update request section 13b. The battery user information mutual management file 11c stores user information on a user of the battery 10. The battery coupon/advertisement use history file 11d stores coupon/advertisement user history information with respect to each battery 10. The battery coupon/advertisement history file 11d may be combined with a management file of customer information (information on the gender and age bracket of a customer) stored in the POS terminal 13.

The POS terminal 13 includes the history reference request section 13a, the history update request section 13b, the individual identification information read section 13c and the coupon price discount section 13d.

The history reference request section 13a issues a history reference request for referring coupon/advertisement history information to the history reference section 11a, and receives the coupon/advertisement use history information sent from the history reference section 11a. The history update section 13b issues a history update request for updating coupon/advertisement use history information to the history update section 11b, and allows the history update section 11b to update coupon/advertisement use history information specified by the history update request. The individual identification information read section 13c reads individual identification information of the battery 10. The coupon price discount section 13d discounts a reduced price specified by a coupon/advertisement file from the selling price of merchandise.

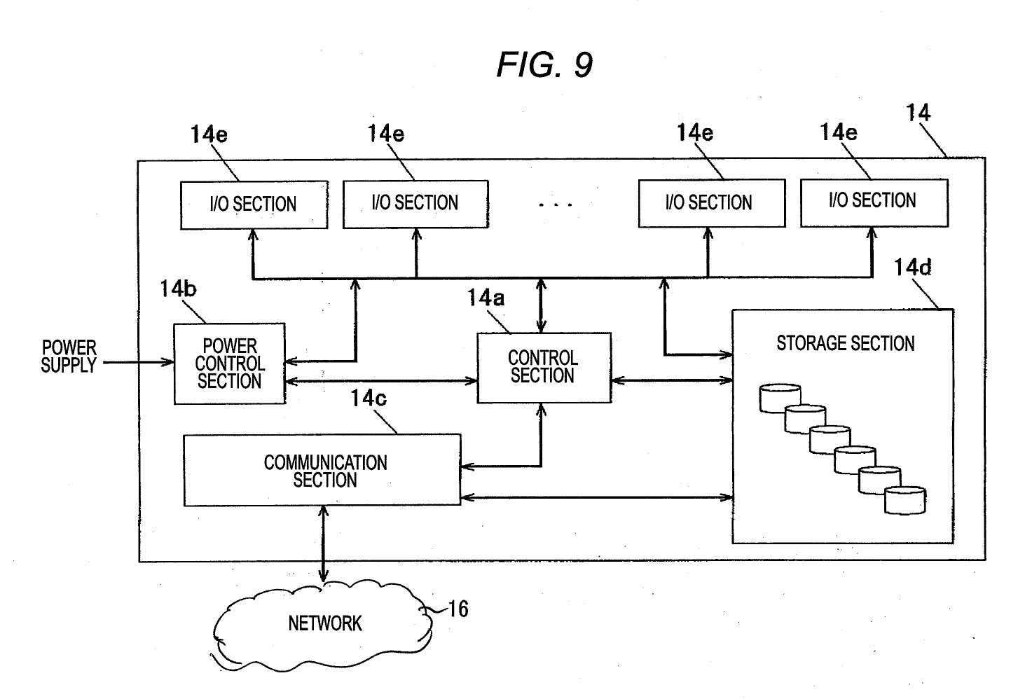

FIG. 9 is a block diagram showing an exemplified structure of the charging station 14 included in the battery utilizing system 1, and conceptually shows a portion thereof concerned with the present invention only. The reference numeral 14 denotes the charging station, a reference numeral 14a denotes a control section, a reference numeral 14b denotes a power control section, a reference numeral 14c denotes a communication section, a reference numeral 14d denotes a storage section and a reference numeral 14e denotes an I/O section.

The charging station 14 includes the control section 14a, the power control section 14b, the communication section 14c, the storage section 14d and the I/O section 14e, all of which are connected to one another so as to be able to communicate with one another via arbitrary communication paths.

The control section 14a is a CPU or the like for generally controlling the charging station 14. The power control section 14b controls electricity flow from an external power supply to the I/O section 14e. Specifically, the power control section 14b supplies electricity to the battery 10 connected to the I/O section 14e by allowing the electricity supplied from the external power supply to flow to the I/O section 14e. The communication section 14c communicates with the network 16. The storage section 14d stores a content (such as a coupon/advertisement file) transmitted from the content management server 11. The I/O section 14e is an interface connectable to the battery 10, and acts as an intermediary in supply of the electricity to the battery 10 and in communication with the battery 10.

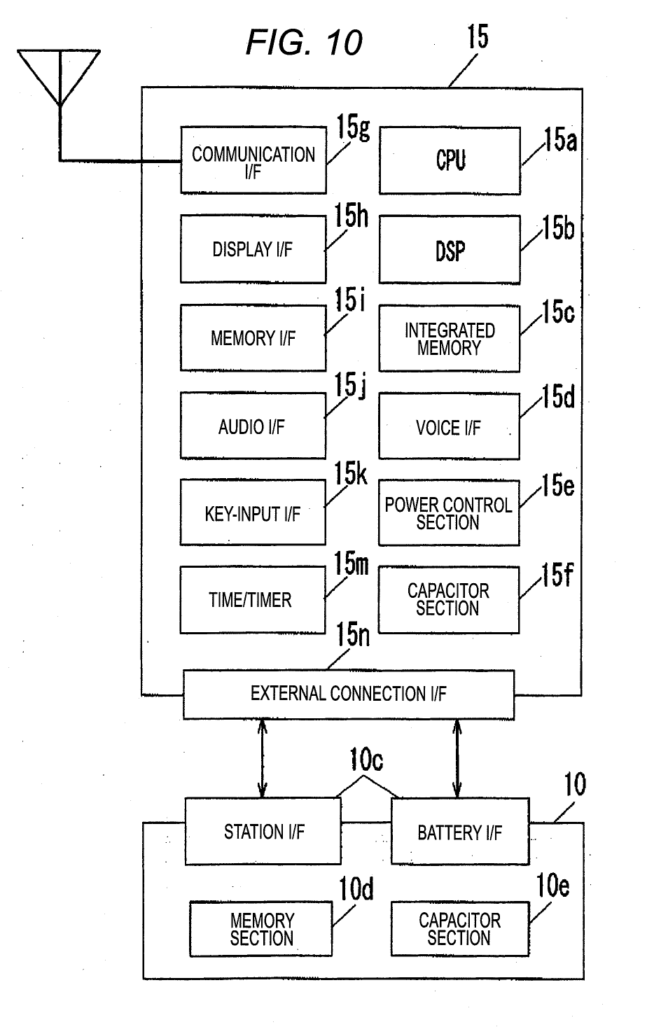

FIG. 10 is a block diagram showing an exemplified structure of the cellular phone 15 included in the battery utilizing system 1 and another exemplified structure of the battery 10 included in the battery utilizing system. In FIG. 10, the reference numeral 15 denotes the cellular phone, a reference numeral 15a denotes a CPU, a reference numeral 15b denotes a DSP, a reference numeral 15c denotes an integrated memory, a reference numeral 15d denotes a voice I/F, a reference numeral 15e denotes a power control section, a reference numeral 15f denotes a capacitor section, a reference numeral 15g denotes a communication I/F, a reference numeral 15h denotes a display I/F, a reference numeral 15i denotes a memory I/F, a reference numeral 15j denotes an audio I/F, a reference numeral 15k denotes a key-input I/F, a references numeral 15m denotes a time/timer, a reference numeral 15n denotes an external connection I/F, the reference numeral 10 denotes the battery, reference numerals 10c denote a station I/F and a battery I/F corresponding to an I/O section, a reference numeral 10d denotes a memory section and a reference numeral 10e denotes a capacitor section.

The cellular phone 15 corresponds to the portable terminal of the present invention, and includes the CPU 15a, the DSP 15b, the integrated memory 15c, the voice I/F 15d, the power control section 15e, the capacitor section 15f, the communication I/F 15g, the display I/F 15h, the memory I/F 15i the audio I/F 15j, the key-input I/F 15k, the time/timer 15m and the external connection I/F 15n, all of which are connected to one another so as to be able to communicate with one another via arbitrary communication paths.

The CPU 15a generally controls the cellular phone 15. The DSP 15b is a digital signal processor. The integrated memory 15c is a storage section for storing information. The voice I/F 15d is an interface for inputting voice, such as a microphone. The power control section 15e controls the flow of electricity stored in the capacitor section 15f. The capacitor section 15f stores the electricity. The communication I/F 15g is an interface for communicating with an external device. The display I/F 15h is an interface for displaying information such as a monitor (a liquid crystal display-screen). The memory I/F 15i is an interface for connecting to an external memory. The audio I/F 15j is an interface for outputting sound such as a speaker. The key-input I/F 15k is an interface for a user to input information such as an operation key, an operation button or a cross button. The time/timer 15m is used for measuring time. It is noted that the portable terminal 15 (and specifically, the CPU 15a) may acquire location information on the location of the portable terminal 15. Also, the portable terminal 15 (and specifically, the CPU 15a) may display, on the display I/F 15h, a content permitted to be output at the location corresponding to the location information on the basis of the acquired location information and output permission range information stored in the battery 10.

The battery 10 includes the I/O section 10c, the memory section 10d corresponding to a battery side storage section of the present invention and the capacitor section 10e. The I/O section 10c includes the battery/F corresponding to an interface for supplying electricity to the cellular phone 15 and the station I/F used for communicating with the cellular phone 15 and the charging station 14.

### 3. Processes Performed in the System

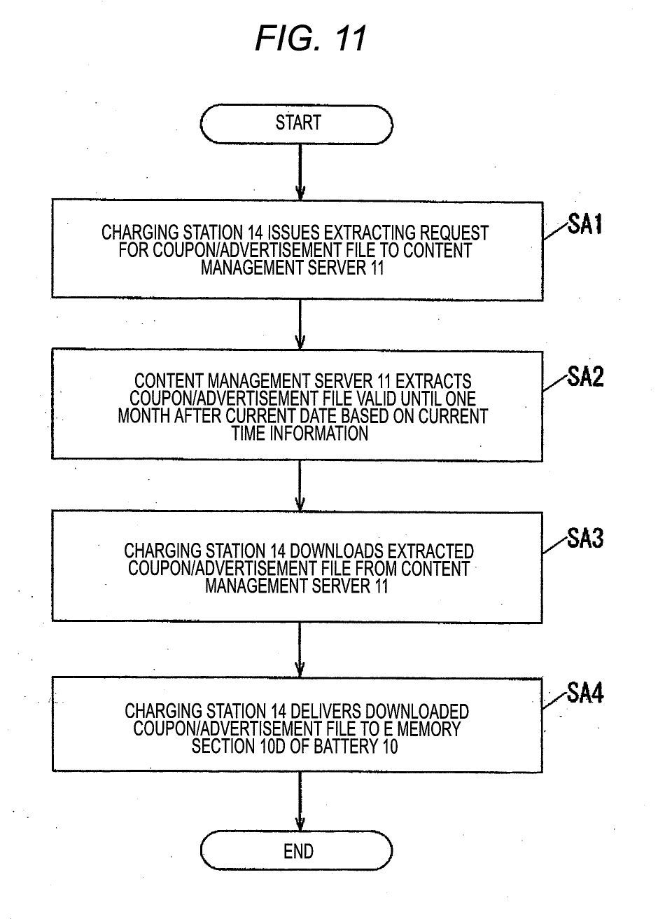

Exemplified processes performed in the battery utilizing system 1 will now be described with reference to FIGS. 11 through 19.

[3-1. In Case of a Content being a Coupon/Advertisement File]

An exemplified process performed in the battery utilizing system 1 in the case where a content is a coupon/advertisement file will be described with reference to FIGS. 1-1 through 16.

[3-1-1. Delivery of a Coupon/Advertisement File to the Battery 10]

FIG. 11 is a flowchart showing exemplified procedures in a process for delivery of a coupon/advertisement file performed in the battery-utilizing system 1. With the battery 10 inserted into the I/O section 14e of the charging station 14, the charging station 14 and the content management server 11 execute the following process.

First, the charging station 14 starts communicating with the content management server 11 via the network 16 (and specifically, the Internet 16a) and issues an extraction request for a coupon/advertisement file to the content management server 11 (SA1).

Next, when the content management server 11 receives the extraction request issued in SA1, it acquires current time information on current date and time and extracts a coupon/advertisement file valid until one month after the current date on the basis of the acquired current time information (SA2).

Next, the charging station 14 downloads the coupon/advertisement file extracted in SA2 from the content management server 11 (SA3).

Then, the charging station 14 delivers the coupon/advertisement file downloaded in SA3 to the memory section 10d of the battery 10 inserted into the I/O section 14e (SA4).

[3-1-2. User Information Registration and Installation of a Coupon/Advertisement Browser Application on Initial Connection of the Battery 10 to the Cellular Phone 15]

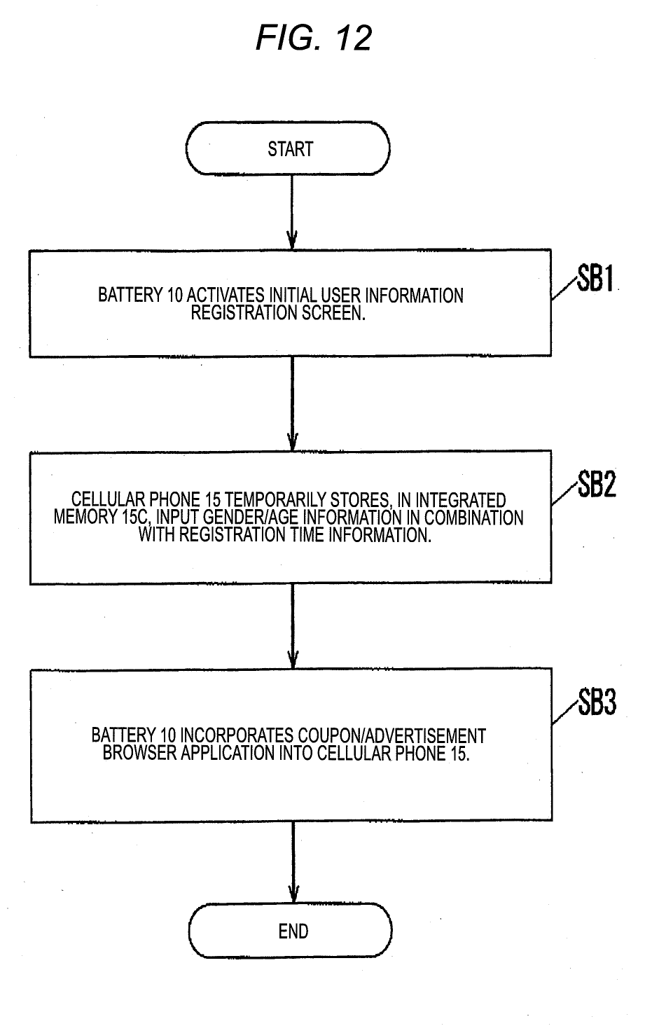

FIG. 12 is a flowchart showing exemplified procedures in a process for user information registration and installation of a coupon/advertisement browser application performed in the battery utilizing system 1. When the battery 10 is inserted into the external connection I/F 15n of the cellular phone 15, the battery 10 and the cellular phone 15 execute the following process.

First, the battery 10 activates an initial user information registration screen stored in the battery 10 on the display I/F 15h of the cellular phone 15 (SB1).

Then, a user operates the key-input I/F 15k of the cellular phone 15 while observing the initial user information registration screen displayed on the display I/F 15h of the cellular phone 15, so as to input the gender/age information on his/her the gender and age.

Next, the cellular phone 15 temporarily stores, in the integrated memory 15c, the input the gender/age information together with registration time information on time and date of the registration (SB2).

Next, the battery 10 incorporates a coupon/advertisement browser application into the cellular phone 15 (SB3).

[3-1-3. Browsing of a Coupon/Advertisement File and Registration of a Favorite]

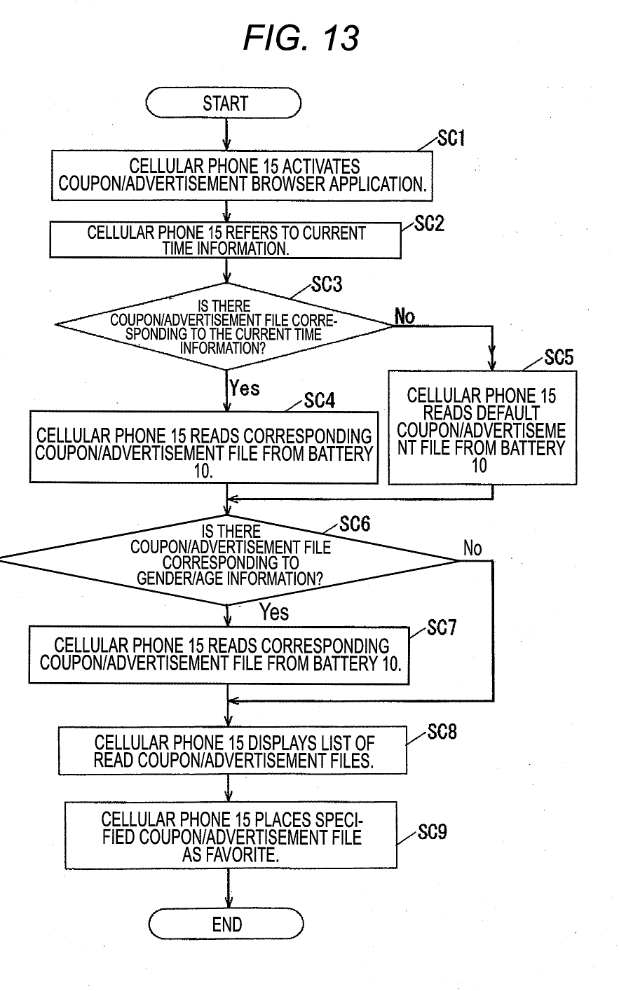

FIG. 13 is a flowchart showing exemplified procedures in a process for browsing of a coupon/advertisement file and registration of a favorite performed in the battery utilizing system 1. When a browsing request for a coupon/advertisement file is issued through key input or a Q code, the cellular phone 15 connected to the battery 10 executes the following process.

First, the cellular phone 15 activates a coupon/advertisement browser application (SC1).

Next, the cellular phone 15 refers to the time/timer 15m for current time information on current date and time (SC2).

Next, the cellular phone 15 searches the battery 10 for a coupon/advertisement file corresponding to the current time information referred to in SC2, and when there is a corresponding coupon/advertisement file (Yes in SC3), the corresponding coupon/advertisement file is read from the battery 10 to the cellular phone 15 (SC4).

On the other hand, when there is no corresponding coupon/advertisement file (No in SC3), a coupon/advertisement file set as a default (such as a ¥50 discount for purchases of ¥500 or more) is read from the battery 10 to the cellular phone 15 (SC5).

Next, the cellular phone searches the battery 10 for a coupon/advertisement file corresponding to the previously registered gender/age information, and when there is a corresponding coupon/advertisement file (Yes in SC6), the corresponding coupon/advertisement file is read from the battery 10 to the cellular phone 15 SC7).

Next, the cellular phone 15 displays a list of coupon/advertisement files read in SC4 or SC5 and coupon/advertisement files read in SC7 on the display I/F 15h (SC8).

Then, a user operates the key-input I/F 15k of the cellular phone 15 while observing the list of the coupon/advertisement files displayed on the display I/F 15h of the cellular phone 15 and the details of each coupon/advertisement file so as to specify a coupon/advertisement file desired for use.

Next, the cellular phone 15 places the specified coupon/advertisement file as a favorite by setting a flag on the coupon/advertisement file (SC9).

In this manner, a coupon/advertisement file to be displayed can be changed corresponding to the time basis or corresponding to the gender or age of a user, and therefore, the frequency of visiting the store or the like can be increased. Furthermore, since a coupon/advertisement file to be displayed can be restricted by the time or date, coupon/advertisement files to be displayed can be effectively narrowed without a user selecting a desired coupon/advertisement file from a large number of coupon/advertisement files through a complicated operation. In this manner, a coupon/advertisement file with a valid period expired or not started can be automatically excluded, and a coupon/advertisement file invalid at the current time can be prevented from being displayed. For example, a coupon/advertisement file valid only after the evening is not displayed in the morning.

Furthermore, since a coupon/advertisement file to be displayed can be changed corresponding to the age bracket, display of an inappropriate coupon/advertisement file (such as display of discount information of alcohol to minors) can be effectively prevented. Moreover, since a coupon/advertisement file to be displayed can be changed corresponding to the POS information, a coupon/advertisement can be strategically displayed. Specifically, a coupon/advertisement file concerned with discount information can be appropriately displayed corresponding to, for example, the stock state (the total stock), the remaining days before a sell-by date or a promotion period of each piece of merchandise, and therefore, undesirable stock (stock of multiple stores within a given district or stock of each store) can be effectively reduced.

Furthermore, since a coupon/advertisement file valid at the current time is extracted from all coupon/advertisement files stored in the battery 10 to be displayed and the rest are not be displayed, the frequency of visiting the store or the like can be kept. Specifically, since information on the future (such as information valid tomorrow) can be set not to be displayed, a user can be made to feel like visiting the store immediately. Moreover, when a user visits the store for exchanging the battery 10, purchase of other merchandise may be expected.

In addition, when advertisements of a variety of companies are stored in the battery 10, an advertisement of a corresponding company can be discriminated (extracted) on the basis of the personal information such as the age and gender to be displayed on the cellular phone 15, and therefore, advertisements can be effectively delivered, resulting in achieving a sales effect expected by advertisers. Also, the personal information such as the gender and age are only registered in the cellular phone 15 and not transmitted to the side of the store, which is preferred from the viewpoint of privacy protection.

Furthermore, since a coupon/advertisement file is guaranteed by a provider of the battery 10, there is no need to perform an operation in danger of virus infection (such as an access to the Web) on the side of the cellular phone 15, and hence, a user can use the battery utilizing system 1 without concern. In particular, since the majority of the elderly are currently uncomfortable using functions other than the e-mail function, such people are preferred as users of the battery utilizing system 1.

[3-1-4. Installation of a Coupon/Advertisement Browser Application and Browsing of a Coupon/Advertisement File Performed on Initial Connection of the Battery 10 to the Cellular Phone 15]

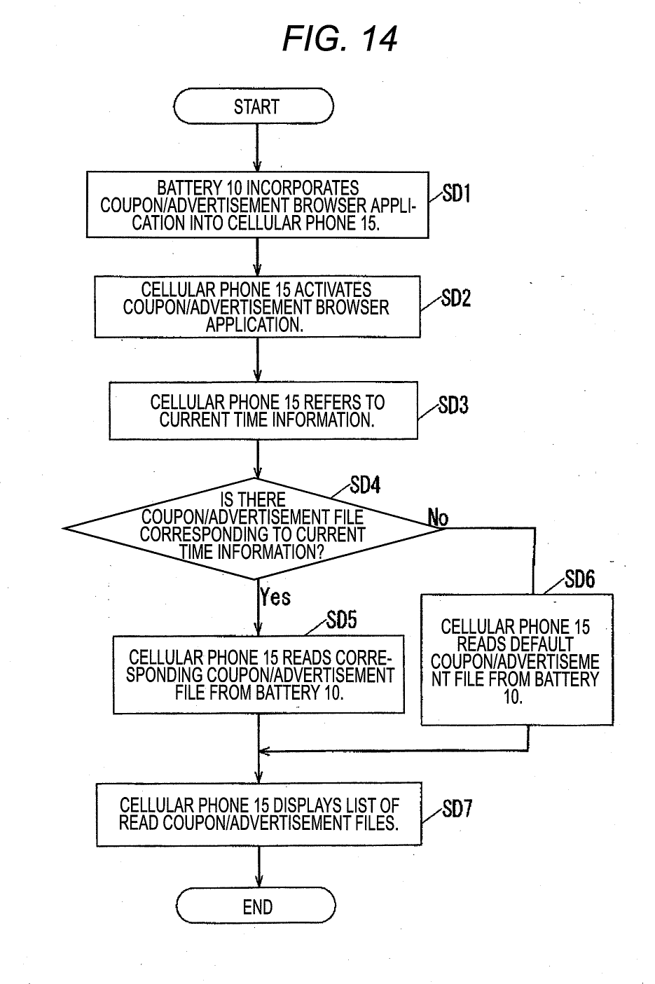

FIG. 14 is a flowchart showing exemplified procedures in a process for installation of a coupon/advertisement browser application and browsing of a coupon/advertisement file performed on initial connection of the battery 10 to the cellular phone 15 in the battery utilizing system 1. When the battery 10 is inserted into the external connection I/F 15n of the cellular phone 15, the following process is executed between the battery 10 and the cellular phone 15.

First, the battery 10 incorporates a coupon/advertisement browser application into the cellular phone 15 (SD1). It is noted that the coupon/advertisement browser application may be created by using, for example, Java (registered trademark).

Next, the cellular phone 15 activates the coupon/advertisement browser application incorporated in SD1 (SD2). For example, the cellular phone 15 may recognize the identification ID of the battery 10 so as to activate a built-in application (an application contained in the cellular phone 15) corresponding to the identification ID.

Next, the cellular phone 15 refers to the time/timer 15m for current timer information on the current date and time (SD3).

Next, the cellular phone 15 searches the battery 10 for a coupon/advertisement file corresponding to the current time information referred to in SD3, and when there is a corresponding coupon/advertisement file (Yes in SD4), the corresponding coupon/advertisement file is read from the battery 10 to the cellular phone 15 (SD5).

On the other hand, when there is no corresponding coupon/advertisement file (No in SD4), a coupon/advertisement file set as a default is read from the battery 10 to the cellular phone 15 (SD6).

Next, the cellular phone 15 displays a list of coupon/advertisement files read in SD5 or SD6 on the display I/F 15h (SD7).

In this manner, an effect equivalent to the effect described in [3-1-3. Browsing of a coupon/advertisement file and registration of a favorite] can be attained. Also, when the battery 10 is inserted into the cellular phone 15, the process shown in FIG. 14 is performed, and therefore, even a user of an age bracket unused to the operation of the cellular phone 15 can easily use the battery utilizing system 1.

[3-1-5. Use of a Coupon/Advertisement File and Settlement (No. 1) through Cooperation with POS]

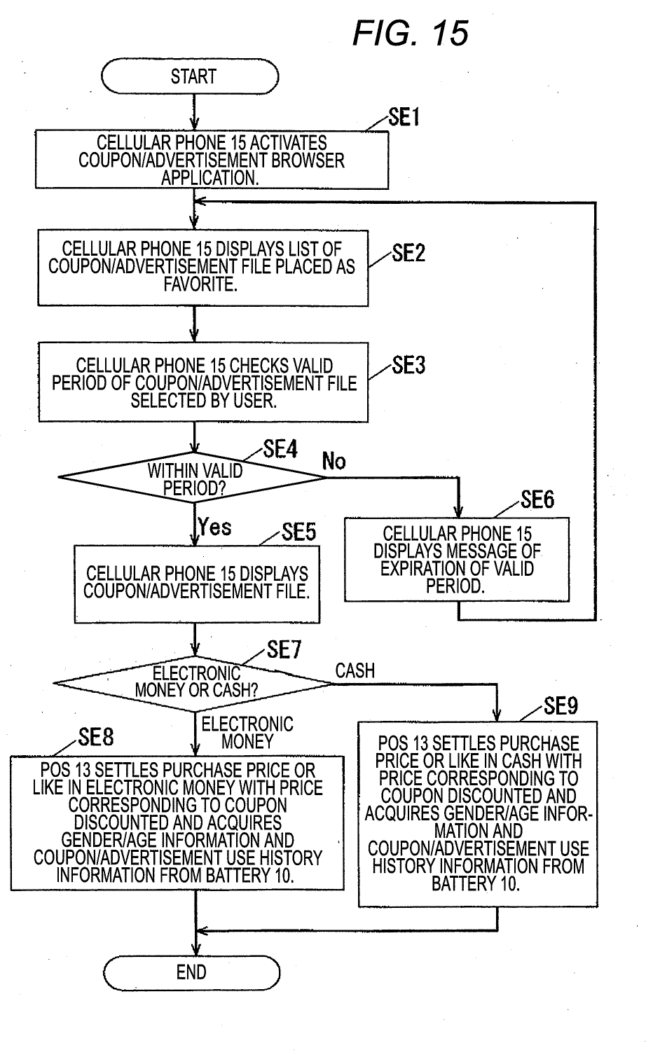

FIG. 15 is a flowchart showing exemplified procedures in a process for use of a coupon/advertisement file and settlement (No. 1) through cooperation with POS performed in the battery utilizing system 1. When a request to browse a coupon/advertisement file is issued, the cellular phone 15 connected to the battery 10 and the POS terminal 13 execute the following process.

First, the cellular phone 15 activates the coupon/advertisement browser application (SE1).

Next, the cellular phone 15 displays a list of coupon/advertisement files previously placed as a favorite on the display I/F 15h (SE2).

Then, a user operates the key-input I/F 15k of the cellular phone 15 while observing the list of the coupon/advertisement files displayed on the display I/F 15h of the cellular phone 15 so as to select a coupon/advertisement file desired for use.

Next, the cellular phone 15 checks the valid period of the selected coupon/advertisement file (SE3), and when the current date is within the valid period (Yes in SE4), the details of the coupon/advertisement file (such as a bar code or a Q code) are displayed on the display I/F 15h (SE5). In checking the valid period, a special coupon/advertisement file may be displayed when it is a specific day previously set.

On the other hand, when the current date is not within the valid period (No in SE4), a message corresponding to expiration of the coupon/advertisement file is displayed on the display I/F 15h (SE6).

Then, the user holds the coupon/advertisement file displayed on the display I/F 15h of the cellular phone 15 over a reader set in the store or the like and selects a settlement method (cash or electronic money).

Next, when the selected settlement method is electronic money (Electronic money in SE7), the POS terminal 13 discounts a reduced price specified by the coupon/advertisement file from the selling price of a target merchandise for settling the purchase price of the merchandise in electronic money, and acquires the gender/age information stored in the cellular phone 15 and the coupon/advertisement use history information stored in the battery 10 (SE8).

On the other hand, when the selected settlement method is cash (Cash in SE7), the POS terminal 13 discounts a reduced price specified by the coupon/advertisement file from the selling price of a target merchandise for settling the purchase price of the merchandise in cash, and acquires the gender/age information stored in the cellular phone 15 and the coupon/advertisement use history information stored in the battery 10 (SE9).

[3-1-6. Use of a Coupon/Advertisement File and Settlement (No. 2) through Cooperation with POS]

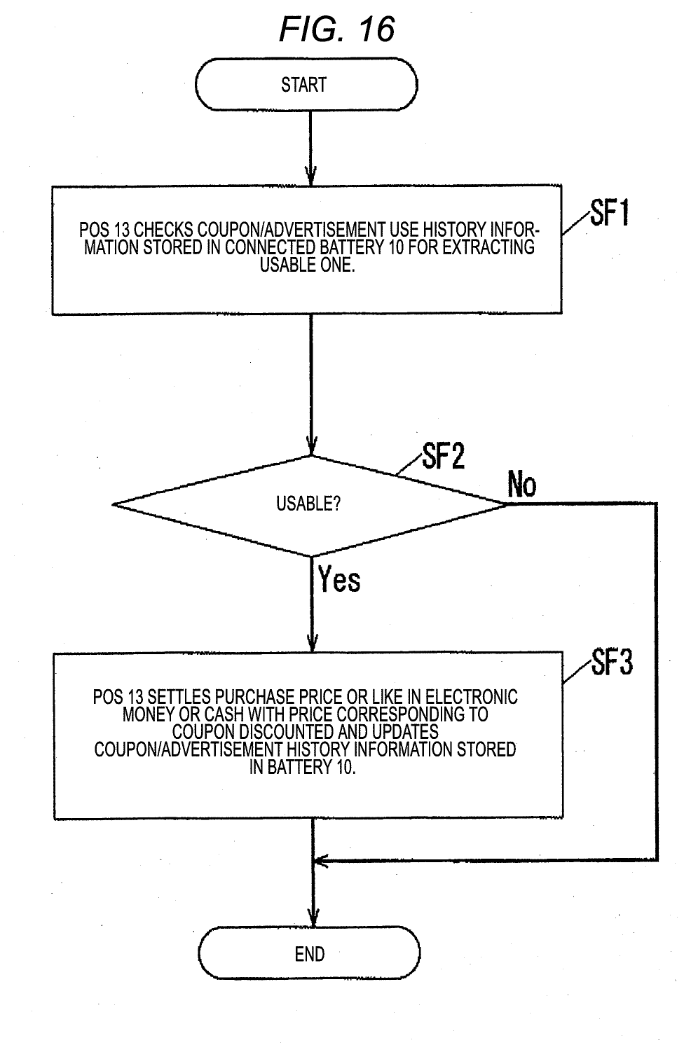

FIG. 16 is a flowchart showing exemplified procedures in process for use of a coupon/advertisement file and the settlement (No. 2) through cooperation with POS performed in the battery utilizing system 1. When the battery 10 is connected to the POS terminal 13, the POS terminal 13 executes a process described below; It is noted that the POS terminal 13 may recognize the battery 10 not only by connecting the battery 10 to the POS terminal 13 but also by using, for example, a bar code or the like of the battery 10.

First, the POS terminal 13 checks the coupon/advertisement use history information in the battery 10 and extracts a usable coupon/advertisement file (SF1). The coupon/advertisement use history information may be managed by the content management server 11 through the POS terminal 13 so that the POS terminal 13 can check the coupon/advertisement use history information from the content management server 11 on the basis of the individual identification information of the battery 10.

Next, when a usable coupon/advertisement file can be extracted in SF1 (Yes in SF2), the POS terminal 13 discounts a reduced price specified by the coupon/advertisement file from the selling price of a target merchandise of the coupon/advertisement file for settling the purchase price of the merchandise in electronic money or cash, and updates the coupon/advertisement use history information stored in the battery 10 (SF3). It is noted that the coupon/advertisement use history information may be managed by the content management server 11 through the POS terminal 13.

[3-2. In Case of a Content being an Electronic Musical Piece, an Electronic Book or Fortune-Telling Information]

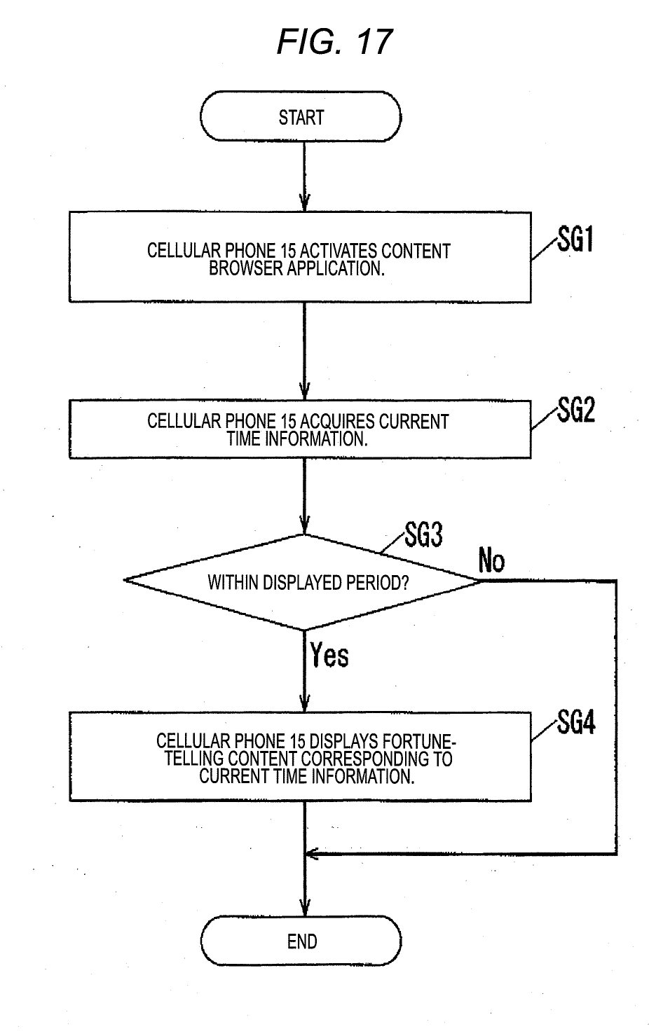

An exemplified process performed in the battery utilizing system 1 in the case where a content is an electronic musical piece, an electronic book or fortune-telling information will be described with reference to FIGS. 17 through 19.

[3-2-1. Browsing of a Fortune-Telling Content]

FIG. 17 is a flowchart showing exemplified procedures in a process for browsing a fortune-telling content performed in the battery utilizing system 1. When a request for browsing a fortune-telling content is issued, the cellular phone 15 connected to the battery 10, which stores a fortune-telling content of one week, executes the following process.

First, the cellular phone 15 activates a content browser application (SG1).

Next, the cellular phone 15 acquires current time information on current date and time from the time/timer 15m (SG2).

Next, the cellular phone 15 searches, on the basis of the current time information acquired in SG2, the battery 10 for a fortune-telling content for a displayed period, and when there is a fortune-telling content for the displayed period (specifically, a fortune-telling content for the current date) (Yes in SG3), the fortune-telling content is displayed on the display I/F 15h (SG4).

[3-2-2. Trial Listening and Purchase of a Music Content]

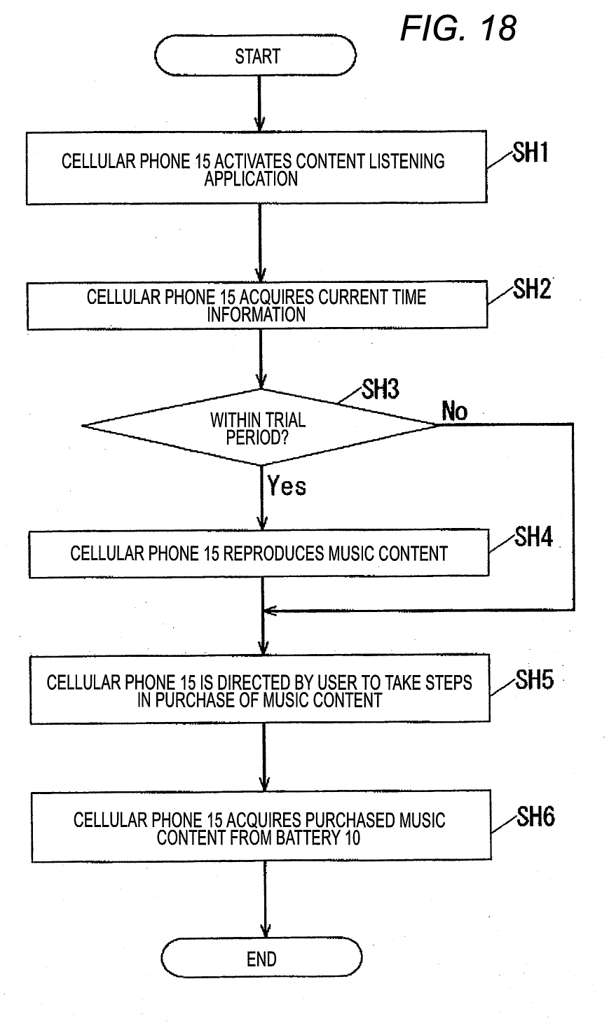

FIG. 18 is a flowchart showing exemplified procedures in a process for trial listening of a music content and purchase of the content performed in the battery utilizing system 1. When a request for trial listening of a music content is issued, the cellular phone 15 connected to the battery 10, which stores a music content able to be listened to for trial for one week only, executes the following process.

First, the cellular phone 15 activates a content listening application (SH1).

Next, the cellular phone 15 acquires current time information on current date and time from the time/timer 15m (SH2).

Next, the cellular phone 15 searches, on the basis of the current time information acquired in SH2, the battery 10 for a music content with a valid trial period, and when there is a music content with a valid trial period (Yes in SH3), the music content is reproduced through the audio I/F 15j (SH4).

Then, a user operates the key-input I/F 15k of the cellular phone 15 for directing the cellular phone 15 to take steps in the purchase of the music content.

The cellular phone 15 takes the steps in the purchase of the music content directed by the user by accessing a web site selling the music content through packet transmission (SH5). When a music content stored in the battery 10 is not purchased, the battery 10 may automatically delete the music content after the trial period has expired.

The cellular phone 15 acquires the music content whose purchase has been completed in SH5 from the battery 10 (and also executes a process for permanently validating the music content), and stores the content in the integrated memory 15c (SH6).

In this manner, since a plurality of musical pieces or the like can be stored in the battery 10, a user can obtain a musical piece or the like inexpensively through download of a short period of time differently from the current principal utilization form where a musical piece or the like is obtained through cellular phone packet transmission expensively through download of a long period of time. Furthermore, when the process for permanently validating a music content or the like is performed through a cellular phone web site, the music content or the like can be acquired with small data communication traffic, and as a result, the load on the wireless communication infrastructure can be reduced and the communication cost can be reduced.

Moreover, validation/invalidation of trial of a music content can be controlled on the basis of the time information obtained by the cellular phone 15 itself. Furthermore, since the number of trials of a music content can be grasped through the operation with the cellular phone 15, the validation/invalidation of trial of the music content can be controlled on the basis of the number. In addition, in purchasing the battery 10 or thereafter, the personal information such as the gender and age can be input or input information can be changed. Also, when a music content of an up-and-coming artist is stored in the battery 10 for delivery, not only the utilization of the battery 10 but also the sales promotion of the music can be realized. Alternatively advertisement information can be randomly delivered, or a music content corresponding to the personal information such as the gender and age can be downloaded in exchanging the battery 10.

[3-2-3. Partial Browsing and Purchase of a Book Content]

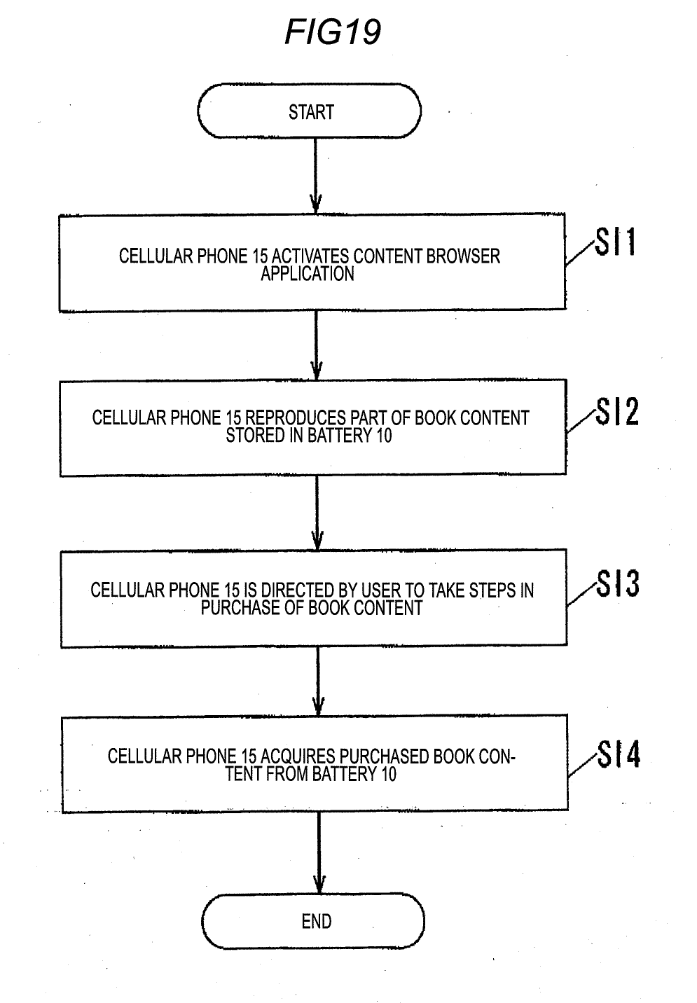

FIG. 19 is a flowchart showing exemplified procedures in a process for partial browsing and purchase of a book content performed in the battery utilizing system 1. When a request for browsing a book content is issued, the cellular phone 15 connected to the battery 10, which stores a book content containing a free trial part, executes the following process.

First, the cellular phone 15 activates a content browser application (S1).

Next, the cellular phone 15 displays, on the display I/F 15h, the free trial part of the book content stored in the battery 10 (SI2).

Then, a user directs the cellular phone 15 to take steps in purchase of the book content by operating the key-input I/F 15k of the cellular phone 15.

Next, the cellular phone 15 takes the steps in the procedure of the book content directed by the user through the packet transmission by accessing a web site for selling the book content (SI3).

The cellular phone 15 acquires the book content (specifically, a part of the book content other than the free trial part) completed in the purchase from the battery 10 (and also executes a process for permanently validating the book content), and stores the content in the integrated memory 15c (SI4).

In this manner, since a plurality of books of comics or novels can be stored in the battery 10, a user can obtain a book or the like inexpensively through download of a short period of time through the battery 10 (or the charging station 14) differently from the current principal utilization form where a book or the like is obtained through cellular phone packet transmission expensively through download of a long period of time. Furthermore, when the process for permanently validating a book content or the like is performed through a cellular phone web site, the book content or the like can be acquired with small data communications traffic, and as a result, the load on the wireless communication infrastructure can be reduced and the communication cost can be reduced.

Furthermore, since the number of trials of a book content can be grasped through the operation with the cellular phone 15, the validation/invalidation of the trial of the book content can be controlled on the basis of the number. In addition, in purchasing the battery 10 or thereafter, the personal information such as the gender and age can be input or input information can be changed.

### 4. Alternative Embodiments

In a museum or an aquarium, a battery 10 storing contents concerned with exhibits put on display such as paintings and animals is lent at the entrance, and thus, the contents can be browsed without consuming the battery of the cellular phone 15.

Alternatively, in a theme park or the like, a battery 10 storing contents concerned with guide information on the theme park and events held on a current data is lent at the entrance, and thus, the contents can be browsed without consuming the electricity of the cellular phone 15. As a result, the cellular phone 15 can be used for taking pictures or the like in the theme park without concern for the battery consumption.

For example, the cellular phone 15 acquires location information on the location of the cellular phone 15, reads a content permitted to be output at the location on the basis of the acquired location information and output permission range information previously set with respect to each content (information on a permitted range of outputting the content), and displays the read content on the display I/F 15h. In this manner, in facilities such as a museum, an aquarium or a theme park, when a user possessing the cellular phone 15 connected to the battery 10 storing contents concerned with exhibits and events of the facilities comes close to a display place of each exhibit or a place for an event (for example, a given range including a display place or an event place), he/she can confirm, via the portable terminal 15, information on the exhibit displayed in that place or the event held in that place.

Alternatively, in the case where the battery 10 storing contents is lent in a museum, an aquarium, a theme park or the like, as compared with the conventional case where a PDA storing contents is lent, the device to be lent is inexpensive and small, and hence, the rent can be suppressed. Therefore, when the income derived from posting of advertisements can be secured, the rent can be free of charge.

Furthermore, since a browsing available period of a content can be limited in the battery utilizing system 1, even when a significant content is included in the lent battery 10, there is no need to withdraw the battery 10. When the income derived from posting of advertisements can be secured, there is no need to return the lent battery 10 and the battery 10 can be distributed free of charge. When the battery 10 can be distributed free of charge, there is no need to take steps in lending the battery 10, and therefore, a queue conventionally formed when lending can be avoided.

Alternatively, the battery 10 can store not only a still image but also a speech or a dynamic image. Also, since it can be determined by a built-in application of the cellular phone 15 whether or not a content stored in the battery 10 has been browsed, a gaming element like Stamp Rally can be incorporated by utilizing information on the determination result.

Many modifications and variations of the present invention are possible in the light of the above techniques. It is therefore to be understood that, within the scope of the invention, the invention may be practiced than as specifically described. The present application is based upon and claims the benefit of priority of Japanese Patent Application No. 2007-286989 filed on Nov. 5, 2007, the contents of which are incorporated herein by reference in its entirety.

What is claimed is:

1. A battery utilizing system, comprising:
a portable terminal; and
a battery that supplies power to the portable terminal,
wherein the battery includes a memory which stores at least one content and an output permission condition which indicates a condition for permitting output of the content; and
wherein the portable terminal includes:
a determining section which determines, on the basis of the output permission condition stored in the memory, whether or not to permit to output the content; and
an outputting section which outputs the content determined by the determining section as a permission of outputting.

2. The battery utilizing system according to claim 1, wherein the content is an electronic coupon.

3. The battery utilizing system according to claim 1, wherein the content is an electronic advertisement.

4. The battery utilizing system according to claim 1, wherein the output permission condition includes a period when the content is valid.

5. The battery utilizing system according to claim 4, wherein the determining section determines whether or not to permit to output the content on the basis of a current date and the period when the content stored in the memory is valid.

6. The battery utilizing system according to claim 1, wherein the output permission condition includes hours of a day when the content is valid.

7. The battery utilizing system according to claim 6, wherein the determining section determines whether or not to permit to output the content on the basis of a current time and the hours of the day when the content stored in the memory is valid.

8. The battery utilizing system according to claim 1, wherein the output permission condition includes a type of a target user of the content.

9. The battery utilizing system according to claim 8, wherein the determining section determines whether or not to permit to output the content on the basis of information on a user of the portable terminal and the type of the target user of the content stored in the memory.

10. The battery utilizing system according to claim 9, wherein the information on the user of the portable terminal includes a gender of the user.

11. The battery utilizing system according to claim 9, wherein the information on the user of the portable terminal includes an age of the user.
